(19) United States
(12) Patent Application Publication
(10) Pub. No.: US 2023/0077147 A1
(43) Pub. Date: Mar. 9, 2023

(54) DATA COPY ACCELERATION FOR SERVICE MESHES

(71) Applicant: Intel Corporation, Santa Clara, CA (US)

(72) Inventors: Yizhou XU, Shanghai (CN); Zhihao XIE, Shanghai (CN); Ziye YANG, Shanghai (CN); Fusheng ZHAO, Shanghai (CN); Kefei ZHANG, Shanghai (CN)

(21) Appl. No.: 17/902,700

(22) Filed: Sep. 2, 2022

(30) Foreign Application Priority Data
Aug. 4, 2022 (CN) PCT/CN2022/110252

(51) Int. Cl. H04L 47/625; H04L 47/10

(52) U.S. Cl. CPC H04L 47/627; H04L 47/16

(57) ABSTRACT

Examples described herein relate to a system for accelerating data operations of a service mesh using a data mover accelerator.

### RELATED APPLICATION

This application claims the benefit of priority to Patent Cooperation Treaty (PCT) Application No. PCT/CN2022/110252 filed Aug. 4, 2022. The entire content of that application is incorporated by reference.

### DESCRIPTION

A service can be executed using a group of microservices executed on different servers. Microservices can communicate with other microservices using packets transmitted over a network. A service mesh can include an infrastructure layer for facilitating service-to-service communications between microservices using application programming interfaces (APIs). A service mesh can be implemented using a proxy instance (e.g., sidecar) to manage service-to-service communications. Some network protocols used by microservice communications include Layer 7 protocols, such as Hypertext Transfer Protocol (HTTP), HTTP/2, remote procedure call (RPC), gRPC, Kafka, MongoDB wire protocol, and so forth. Envoy Proxy is a well-known data plane for a service mesh. Istio, AppMesh, and Open Service Mesh (OSM) are examples of control planes for a service mesh data plane.

Service meshes can act as an ingress gateway or sidecar proxy and can encrypt or decrypt data, compress or decompress data, modify headers of packets, and convert protocols for incoming and outcoming connections and requests. A service mesh can utilize a cloud native network proxy distributed runtime that performs data copy and movement operations. Latency of communications on connections can be affected by delays in notifications of completions of data copying operations whereby a data copy operation has completed by the service mesh stalls operation while waiting for a notice of completion.

### BRIEF DESCRIPTION OF THE DRAWINGS

FIG. 1 depicts an example system.

FIG. 2 depicts an example system.

FIG. 3 depicts an example process to allocate a work queue to a network processing thread in accordance with the example of operations.

FIG. 4 depicts an example of allocation of threads to work queues of a data mover accelerator.

FIG. 5 shows an example of submissions of memory copy requests to a data mover accelerator.

FIG. 6A depicts an example of data mover accelerator utilized by Minivoy.

FIG. 6B depicts an example of use of TLS_WRITE for memory copy operations.

FIG. 7 shows a timing diagram.

FIG. 8 depicts an example of utilization of user interrupts.

FIG. 9 shows an example of operations for interrupt generation.

FIG. 10 depicts latency breakdown of a single 4 KB size memory copy by a data mover accelerator.

FIG. 11 shows an estimated latency breakdown for hardware interrupt.

FIG. 12 shows the latency breakdown comparison between data mover accelerator in polling mode, with hardware interrupt and user interrupts.

FIG. 13 depicts an example process.

FIG. 14 depicts an example computing system.

FIG. 15 depicts an example computing system.

### DETAILED DESCRIPTION

At least to reduce latency of data processing operations of one or more threads executed for a service mesh and reduce delay from start of an operation after a data copy operation and reduce central processing unit (CPU) utilization, memory read and write operations by the service mesh can be offloaded to a data mover accelerator. Examples of a data mover accelerator include a direct memory access (DMA) circuitry, Intel® Data Streaming Accelerator (DSA), or other devices. DSA includes a streaming data accelerator in which data copies and data processing can be offloaded from a processor (e.g., CPU, graphics processing unit (GPU), or other accelerator) at least for storage, persistent memory, and networking operations.

In some examples, a scheduler for the service mesh (e.g., code executed in a thread by a CPU) can allocate a queue, from which a data mover selects work to perform by batching work requests, to a network processing thread executed for the service mesh based on depth of the queue (e.g., number of unperformed work requests in the queue). In some examples, one or more threads executed by a processor for a service mesh can provide work requests (e.g., memory read or write) to a queue from which a data mover selects work to perform by batching work requests.

In some examples, a network processing thread, of the service mesh, that requested the data mover to perform a batch of one or more work request can poll to determine if a work request has completed to determine whether to move forward or proceed to a next operation (e.g., encryption). In some examples, a service mesh can receive an indicator of work request completion by a user interrupt.

In some examples, to provide a differentiated service according to the priority for the connections, memory read or write operations for data movement operations among different memory spaces for connections inside multiple-thread network applications (e.g., service mesh applications) can be performed by a CPU or data mover accelerator. Connections serviced by threads that use data mover accelerator can have lower latency than those serviced by CPU and higher priority than those serviced by CPU for memory copy operations.

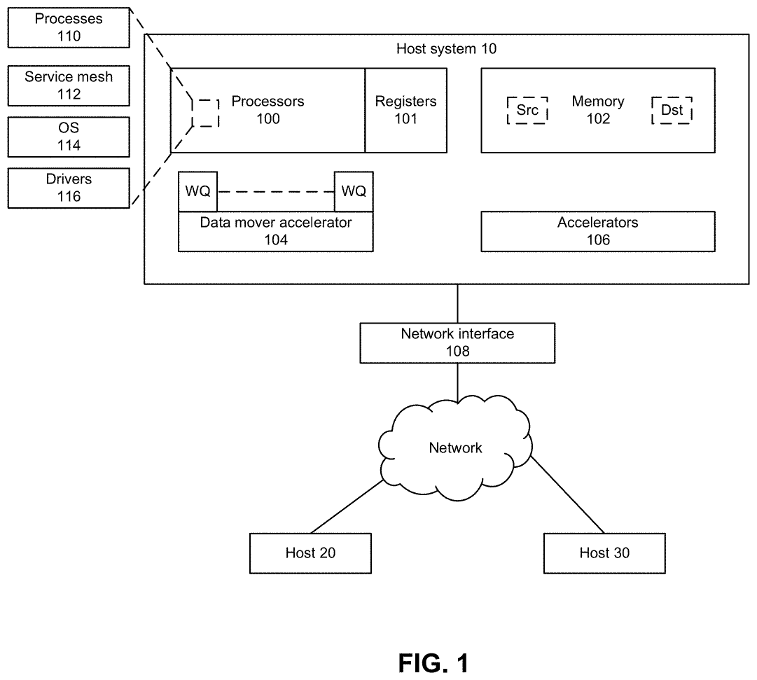

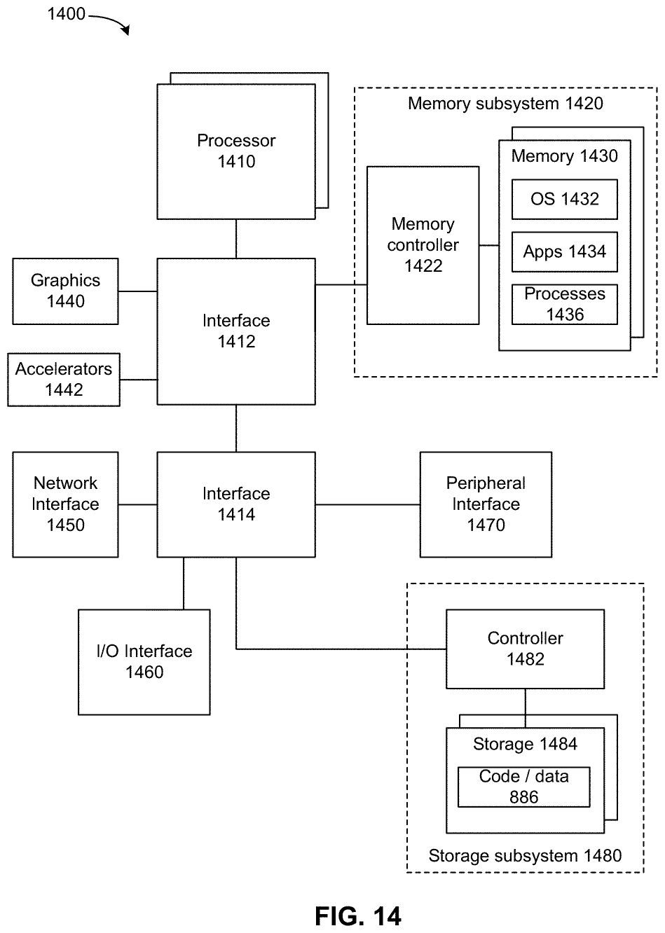

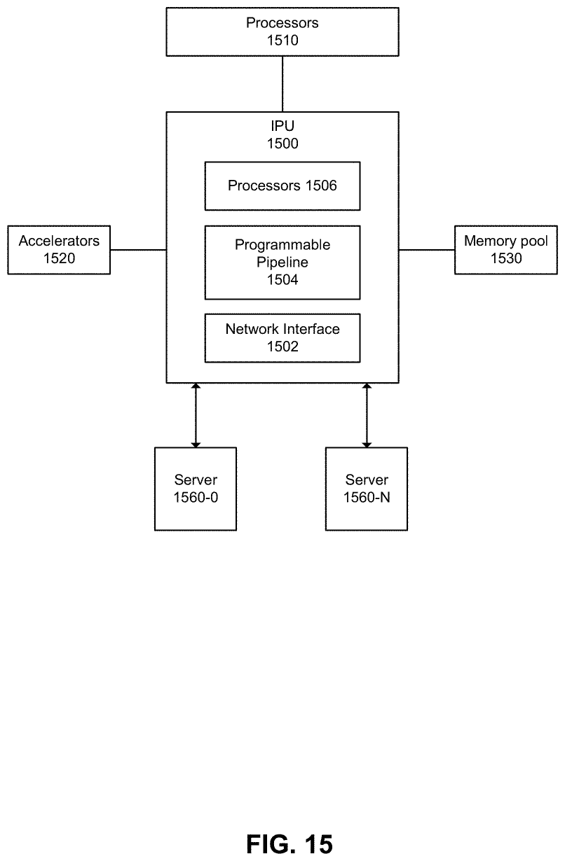

FIG. 1 depicts an example system. Host system 10 can include processors 100 that execute one or more of processes 110, service mesh 112, operating system (OS) 114, and device driver 116. Various examples of hardware and software utilized by the host system are described at least with respect to FIGS. 14 and 15. For example, processors 100 can include a CPU, graphics processing unit (GPU), accelerator, or other processors described herein. Processes 110 can include one or more of: application, process, thread, a virtual machine (VM), microVM, container, microservice, or other virtualized execution environment. Service mesh 112 can be utilized to provide communications between processes 110 and other processes executed by processors 100, accelerators 106, processes executed by processors accessible via communications through network interface 108. Service mesh 112 can perform an ingress gateway or sidecar proxy, which can encrypt or decrypt data, compress or decompress data, modify packet headers, and convert protocols for incoming and outcoming connections and requests. Service mesh 112 can maintain a separated slice array to decompose and buffer incoming data for modification. For example, processes 110 can utilize service mesh 112 to communicate with other processes (e.g., microservices or as part of function as a service (FaaS)) executed by host system 10 or executed by host system 20 and/or 30 via network interface 108.

Microservices can communicate using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can include a service on a network that an application can invoke. A microservice can include one or more of: polyglot programming (e.g., code written in multiple languages to capture additional functionality and efficiency not available in a single language), or lightweight container or virtual machine deployment, and decentralized continuous microservice delivery. Various examples can utilize an orchestrator to deploy microservices for execution such as Kubernetes, Docker, OpenStack, Apache Mesos, and so forth.

As described herein, for connections involving data communications that are a priority level at or above a configured level, service mesh 112 can utilize data mover accelerator 104 to offload data copy operations to and from memory 102 as well as between memory 102 and network interface 108. Data copy operations can be used in connection at least with packet decryption, packet encryption, or packet mirroring. For example, as described herein, a scheduling thread or process can allocate one or more work queues of data mover accelerator 104 to one or more network processing threads of service mesh 112 based on load of the work queue. For example, as described herein, one or more network processing threads of service mesh 112 can provide data mover descriptors or work requests to data mover accelerator 104 in a batched or coalesced manner. For example, as described herein, network processing threads of service mesh 112 can poll for notice of completion of a submitted workload to data mover accelerator 104 in order to attempt to reduce a time between a data copy operation completion and time to start a next operation such as data encryption. For example, as described herein, data mover accelerator 104 can inform one or more network processing threads of service mesh 112 of completion of a data copy operation based on a work request using user interrupts written to one or more of registers 101.

Drivers 116 can provide processes 110, service mesh 112, or OS 114 with communication to and from and utilization of data mover accelerator 104, accelerators 106, network interface 108, or other devices. For example, service mesh 112 can utilize one or more of drivers 116 to submit work requests (e.g., descriptors) to a work queue (WQ) accessible by data mover accelerator 104 and to determine whether operations requests by a descriptor have completed. For example, a work request can request a data copy operation from a source to destination in memory 102 or to or from memory 102.

Data mover accelerator 104 can include a direct memory access (DMA) circuitry to perform data copy operations offloaded from a CPU. Data mover accelerator 104 can execute one or more instructions to copy data from a source memory address (Src) to a destination memory address (Dst) within memory 102 or to or from memory 102. Memory 102 can include volatile memory and/or non-volatile memory. In some examples, memory 102 can include a memory pool with dual inline memory modules (DIMMs). In some examples, instructions can be submitted as descriptors by processes 110 and/or service mesh 112 to one or more WQs. Data mover accelerator 104 can perform one or more of: data move or copy, verify the integrity of data or information, cyclic redundancy check (CRC) checksum generation on data to be transmitted, filling a section of memory with a specific data repeatedly to erase content of a part of the memory, compare two memory blocks and check if they are identical, generate a data stream indicating difference between two data streams, or others. In some examples, data mover accelerator 104 can be part of a same integrated circuit or semiconductor die as that of a CPU or GPU. In some examples, data mover accelerator 104 can be in a separate integrated circuit or semiconductor die from that of a CPU or GPU.

Network interface 108 can receive packets directed to processes 102 and/or service mesh 112 and transmit packets at the request of processes 102 and/or service mesh 112. Network interface 108 can refer to one or more of the following examples: a data processing unit (DPU), infrastructure processing unit (IPU), smartNIC, forwarding element, router, switch, network interface controller, network-attached appliance (e.g., storage, memory, accelerator, processors, security), and so forth.

Various examples of accelerators 106 are described herein and can be used to perform encryption, decryption, packet mirroring, machine learning inference operations, or other operations on data stored in memory 102.

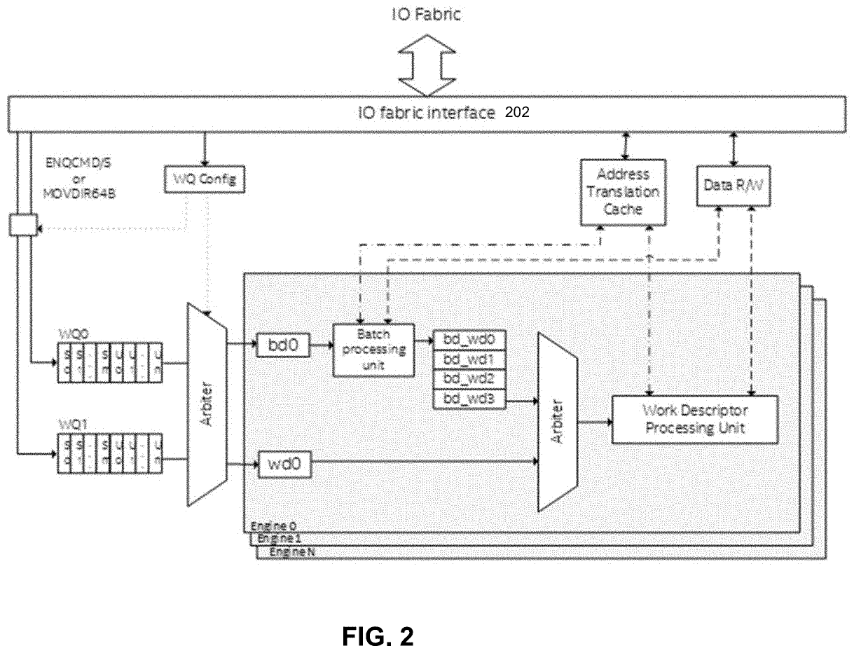

FIG. 2 depicts an example data mover accelerator. I/O fabric interface 202 can receive work requests from clients and provide upstream read, write, and address translation operations. Work Queues (WQ) can queue descriptors. A client can submit work descriptors using the ENQCMDS, ENQCMD, or MOVDIR64B instruction. Engines 0 to N can retrieve work submitted to the WQs and perform the work specified by the descriptor. Engines 0 to N can perform one or more of: data move or copy, verifying the integrity of the information in the memory, CRC checksum generation on data, memory erase operations, comparing if two memory blocks are identical, generating a data stream indicating difference between two data streams, or others.

If multiple threads serve different connections compete for use of WQs, performance of operations can be slowed. To reduce latency caused by overloaded work queues, a side car thread or scheduling thread of memory copy operations for a service mesh can perform the following example of operations below to allocate a WQ to a network packet processing thread of a service mesh. The scheduling thread can map a network processing thread and to WQs 1-to-N.

### Example of Operations

1) Initialize the data mover accelerator WQs and maintain a list of mover accelerator WQs in the multiple-thread service mesh application based on start of application. Data mover accelerator WQ can be marked with one of three different states: <idle, busy-not-full, busy-full>, where idle indicates WQ is not used, busy-not-full indicates WQ is used and still can accept offload requests, and busy-full indicates WQ is busy with full offload.
2) In response to creation of a network processing thread to process packets received on one or more connections or to be transmitted on one or more connections, the workload of the CPU that executes the network processing thread can be monitored.
1) If CPU resource is not busy with user defined threshold ratio (e.g., <50% utilization or other values), then the data mover accelerator is not used to perform data copy operations.
2) If the CPU bounded by this thread is busy with user defined threshold ratio (e.g., >50% utilization or other values), then one or more DSA WQ are selected for use.
   a) If a WQ with <busy-not-full> state is found, then check whether this WQ becomes to <busy-full> state if work is added to this WQ. If the WQ does not become <busy-full> state if work is added to this WQ, assign this WQ to this thread.
   b) If WQ with <busy-not-full> state is not found, then find a WQ with <idle-state> and move such WQ with <idle> state to WQ<busy-not-full state> and assign such WQ to this thread.
   c) If no WQ with <idle> and <busy-not-full> state, then the CPU can perform memory copy operations and not utilize the data mover accelerator.
      3) Based on destruction or ending of the thread, check whether WQs are bound or assigned to the thread. If there are bound WQs, then check WQ in the used WQ list to determine whether to unbind the WQ. If a WQ is in <busy-full-state> and includes one or more free entries, change the WQ state to <busy> because there are still other threads able to use the WQ and unbind this WQ from the thread.

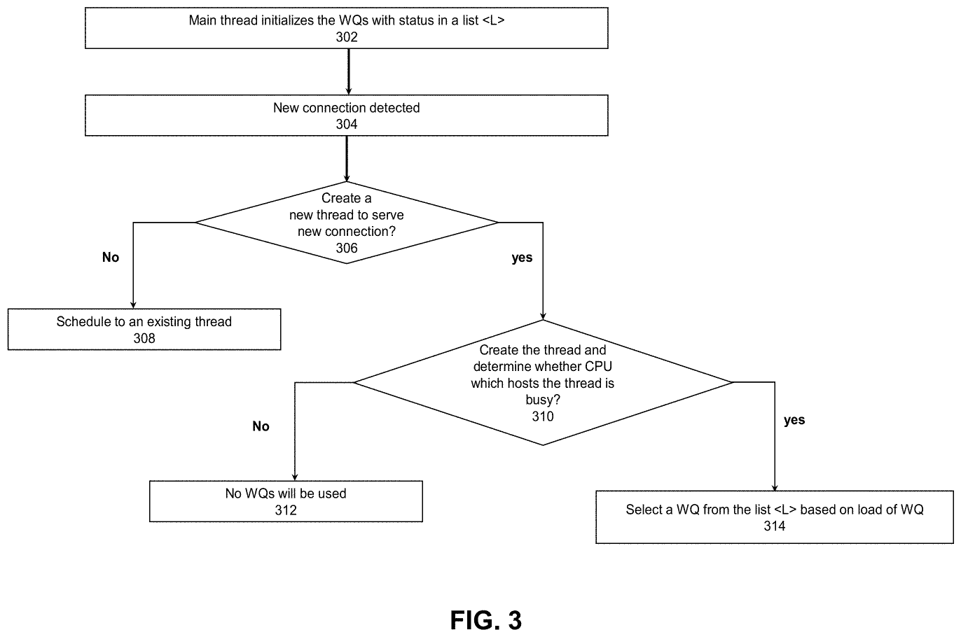

FIG. 3 depicts an example process to allocate a work queue to a network processing thread in accordance with the example of operations. At 302, a scheduler (e.g., main thread) can initialize data mover accelerator work queues with load status. For example, the work queues can be allocated a load status of <idle>, <busy-not-full>, or <busy-full> state.

At 304, a new connection that can be used to receive or transmit packets to a service mesh is identified. At 306, a determination can be made of whether to create a new thread to perform network processing of packets of the new connection. If an existing thread is available to perform network processing of packets of the new connection, then at 308, the existing thread can be scheduled to perform network processing of packets of the new connection. If an existing thread is not available or efficient to perform network processing of packets of the new connection, then at 310, a determination can be made whether the CPU is capable of performing memory copy operations. Based on a load level of the CPU being at or below a threshold, at 312, the CPU can be assigned to perform memory copy operations and a data mover accelerator work queue is not assigned to the thread. Based on a load level of the CPU being above the threshold, at 314, a data mover accelerator work queue can be assigned to the thread based on a load level of the work queue, as described herein.

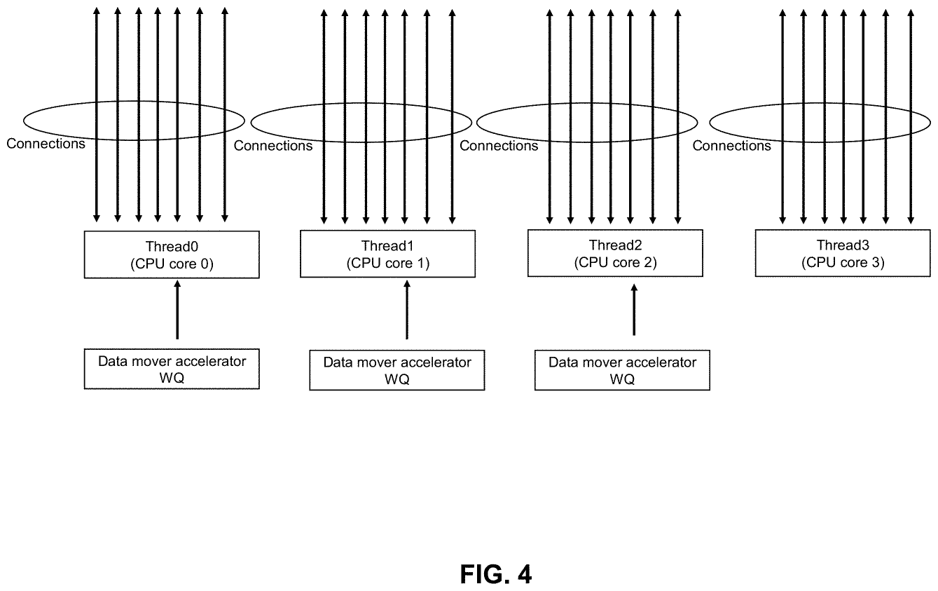

FIG. 4 depicts an example of allocation of threads to work queues of a data mover accelerator. A thread can perform network processing for packets of one or more connections within a service mesh such as side car. As described herein, one or more threads or cores can utilize batched work submissions and asynchronous, polled, or interrupt-based result checking of completion of work submissions.

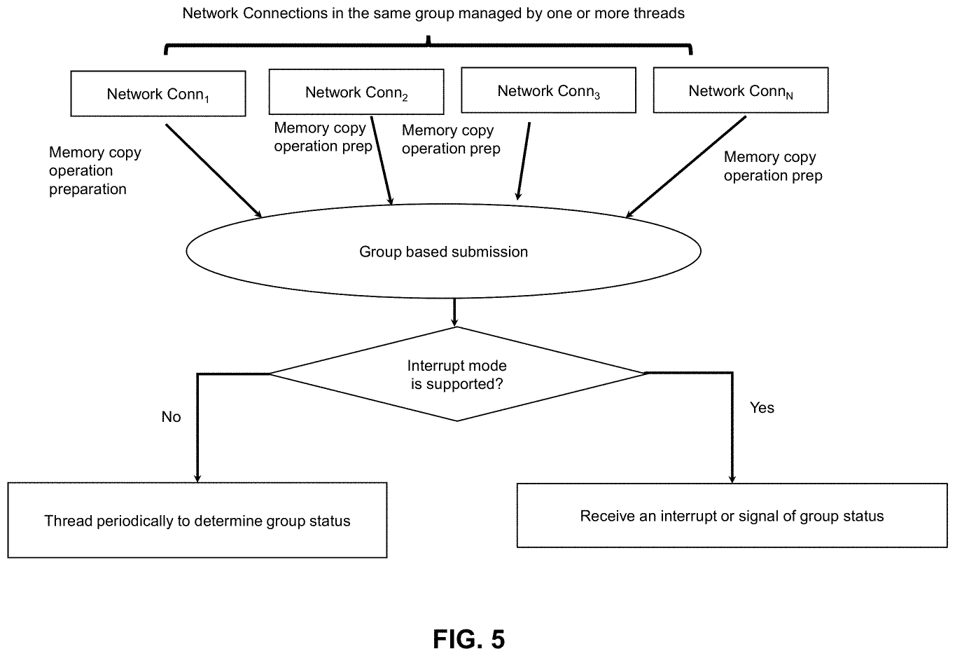

FIG. 5 shows an example of submissions of memory copy requests to a data mover accelerator. One or more threads can perform network protocol processing of packets to be transmitted by a service mesh or received by a service mesh. For example, one or more threads can process received packets or to-be transmitted packets for network connections 1 to N (e.g., Transmission Control Protocol (TCP) connections). In some examples, one or more threads can issue memory copy preparation requests for one or more connections in a group or batch to a data mover accelerator driver. A group or batch can include one or more descriptors requesting data copy operations.

For connections managed by a thread, a dispatcher of network processing thread can submit work requests to data mover accelerator in a batched manner for multiple connections to request memory copy operations. A batch of memory copy requests can be sent based on reaching a threshold number of descriptors or expiration of a timer. For example, the memory copy preparation requests can request copy of data from a source address to destination address. In some examples, a memory copy preparation can utilize API async_DSA_prep_memcopy (cb, cb_args). Data mover accelerator driver can submit the group of one or more memory preparation requests to the data mover accelerator to perform.

Data mover accelerator driver can write a status of the group of requests to a field in a submitted descriptor. For example, status can include completed or failed or others. Asynchronous operations can be applied to check for status (e.g., completion or failure to complete) submitted work requests. Asynchronous operations can lessen a time that the CPU stalls waiting for a field in submission command indicating operating completed or failed. To check completion of a batch of data copy operations for one or multiple connections, the dispatcher thread (or other thread) can poll for a completion indication or receive an interrupt indicating completion. To poll for a completion indication, the dispatcher thread (or other thread) can check a completion field of a submission operation and invoke its post activity (e.g., call the callback function with arguments, e.g., cb(cb_args)). To receive an interrupt indicating completion, the data mover accelerator can issue a user interrupt that identifies the memory submission operation and invoke its post activity (e.g., call the callback function with arguments, e.g., cb(cb_args)). Based on failure of completion of a group-based submission, the request may be re-submitted to a data mover accelerator driver.

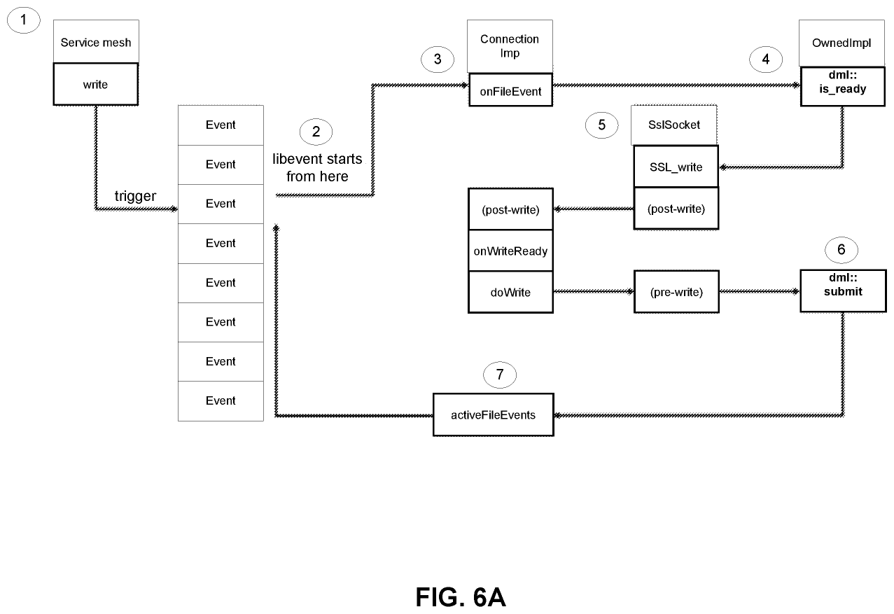

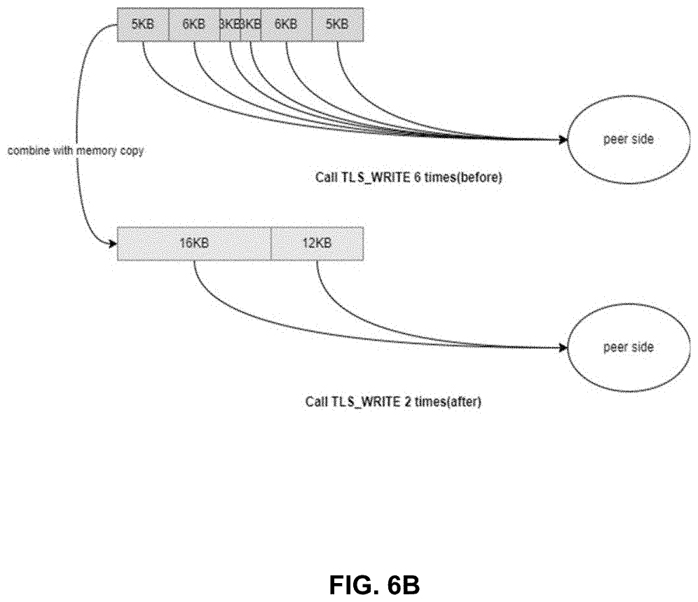

FIG. 6A depicts an example of data mover accelerator utilized by a service mesh. In this example, the minivoy/Envoy service mesh from Lyft and Cloud Native Computing Foundation can utilize a data mover accelerator. For example, to check for a status update on a submitted work request to the data mover accelerator, a loop can be executed by a scheduler thread of a service mesh to check the read/write events for connections served by a CPU core.

At (1), a service mesh can issue an event for a connection. When the connection is ready to read (e.g., a network interface device receives data), the corresponding event can be marked as ready to read. An event can include a request to copy data. Envoy can utilize Libevent thread dispatcher running in service mesh application to detect an event. At (2), when the event is scanned by libevent, a callback can be triggered (e.g., memory copy, encryption, and writing out encrypted data). Service mesh dispatch libevent can detect if there is an external write operation (e.g., Linux file descriptor) from a network processing thread and trigger an event. At (3), Envoy can utilize onFileEvent to detect a read event and progress to dml:is_ready.

At (4), Envoy dml:is_ready can check a completed field in an event descriptor to determine a status of the operation associated with the descriptor. Envoy dml:is_ready can check if one or more submitted write operations are completed. At (5), Envoy SslSocket can request SSL_write to encrypt data referenced by a Linux® file descriptor. At (6), Envoy dml:submit can use application program interfaces (APIs) to trigger another write operation by submitting another descriptor to the data mover accelerator.

At (7), Envoy activeFileEvents can check if the another descriptor is completed. The process can return to (1).

Although examples are described with respect to Envoy service mesh, other service meshes can utilize technologies described herein, such as, but not limited to: LinkerD, AppMesh, Open Service Mesh (OSM), Istio, Consul, Kuma, Maesh, or others.

In some examples, an application (e.g., service mesh) can utilize polling to identify a status update of a work request submitted to the data mover accelerator. Instead of passively waiting for interrupts, actively polling for description completion can reduce the average latency in the cost of CPU usage, which can be adopted in applications such as Data Plane Development Kit (DPDK), OpenDataPlane (ODP), and Storage Performance Development Kit (SPDK).

FIG. 6B depicts an example of use of TLS_WRITE for memory copy operations. Envoy can encrypt HTTPS requests with TLS_WRITE operation prior to transmission of packets to a peer side. Combining buffers into a larger one can reduce a number of buffers sent with TLS_WRITE, which can provide lower latency.

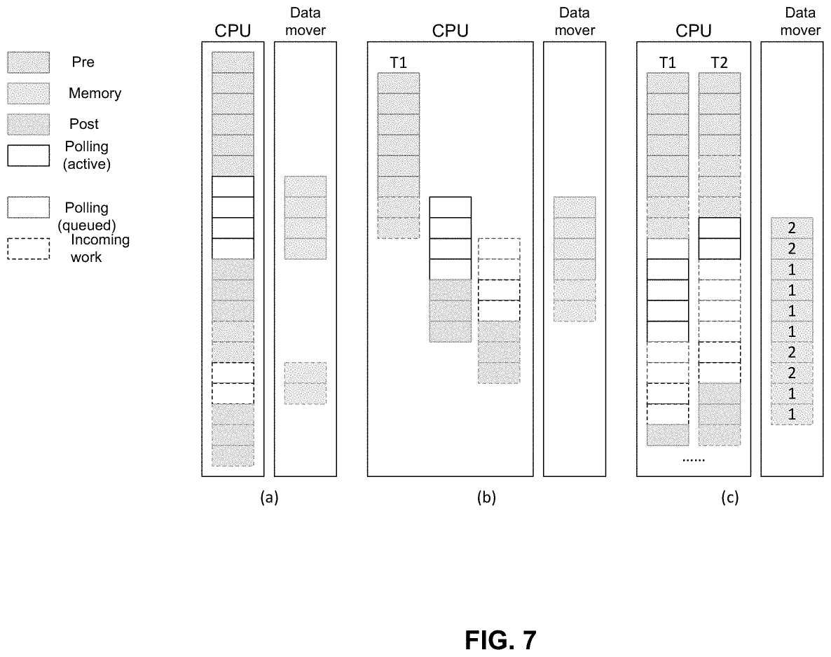

FIG. 7 shows a timing diagram. White and grey blocks represent time occupied by the CPU performing polling. The white blocks indicate that the CPU is polling the data copy request queued in the polling queue. Other colored blocks indicate a procedure for a fine-grained object such as an event of a connection in network. As shown, the CPU can utilize clock cycles to perform polling that could otherwise be used to perform computations or process workloads.

In FIG. 7, scenario (a) shows pausing and waiting for completion of each workload submitted to the data mover accelerator. Scenario (b) shows dispatching a new thread for polling and handling callback from execution by data mover accelerator of a workload. Scenario (c) shows polling by threads (T1 and T2) after submitted batch operations to the data mover accelerator, which performs workloads from T1 and T2 (shown as 1 and 2, respectively).

At least to provide utilization of a data mover accelerator by service mesh applications, such as applications that utilize an event driven I/O models, a data mover can issue user interrupts in user space to the service mesh application. For example, data mover accelerator can issue an interrupt in user space to network processing thread to indicate copy completion or completion of a submitted batch of requests. Data mover accelerator can send interrupts to a CPU, bypassing a kernel, to indicate that a job is complete. A user interrupt can bypass kernel space and be associated with an interrupt vector. A user interrupt can be processed by an input output memory management unit (IOMMU) circuitry to convert a Message Signalled Interrupts (MSI) interrupt to a user interrupt. Communication from data mover accelerator to application can occur by user interrupts to middleware such as signals in an event driven I/O model or event driven and non-blocking I/O model. An event driven I/O model or event driven and non-blocking I/O model can include registering an event that will be called when data fetching is finished and freeing an event-cycle to take a next request

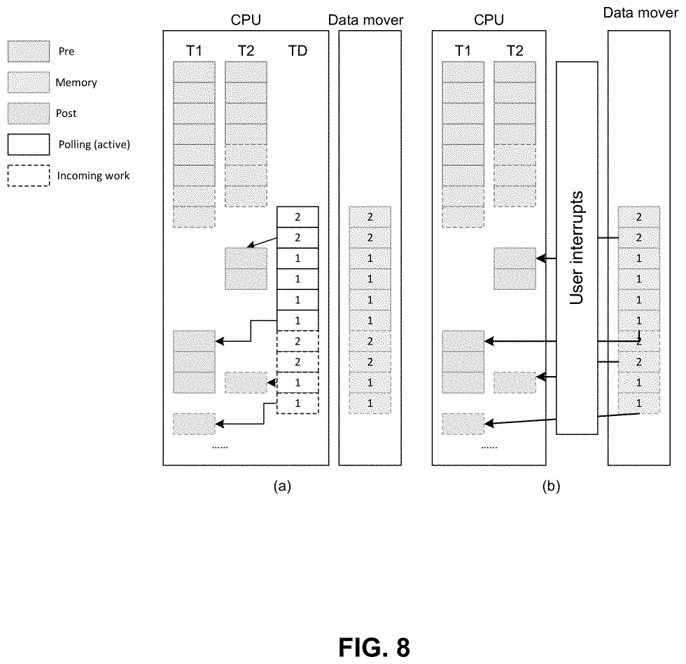

FIG. 8 depicts an example of utilization of user interrupts. In scenario (a), threads T1 and T2 can issue workload requests to data mover accelerator and an independent thread (TD) can handle queuing, batch merging, submitting, and polling or waiting for communications with data mover accelerator. Data mover accelerator operations can be wrapped as an event which can be integrated into an event driven I/O model. Thread TD can continuously poll the data mover accelerator driver to retrieve results of the workload requests.

In scenario (b), data mover accelerator can send user interrupt(s) by writing a signal vector to a register of a CPU to trigger an interrupt handling of identifying a status update of a workload request. Data mover accelerator can trigger a user interrupt to the working thread (e.g., T1 or T2) after the completion of a workload request. Based on the working thread confirming that a data mover accelerator operation has completed, the working thread can activate the corresponding event according to the signal vector as the user interrupt corresponds to a signal vector that indicates data mover accelerator has completed a memory copy operation from a workload request.

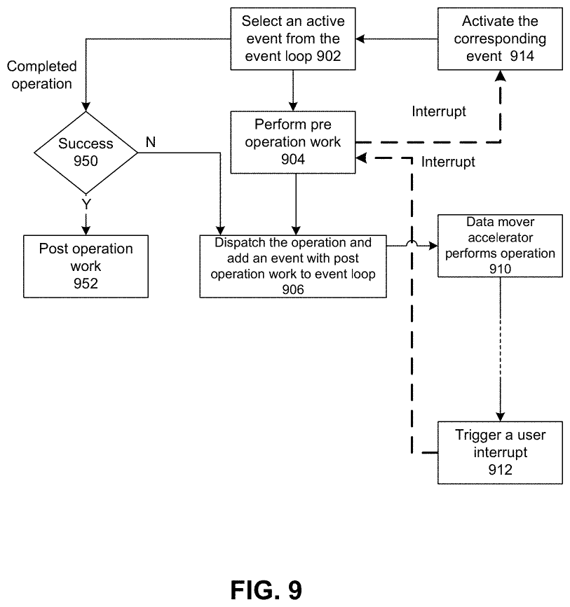

FIG. 9 shows an example of operations for interrupt generation. At 902, an active event (e.g., copy request) can be selected. At 904, pre-operation work can be performed such as data modification, validation, and analysis. At 906, the operation associated with the event can be dispatched to the data mover accelerator and post-operation work can be added to an event loop. Post-operation work can include encrypt data or mirror. At 910, the data mover accelerator can perform the operation (e.g., data copying from a source memory address to a destination memory address). At 912, based on completion of the operation, a user interrupt can be issued to a thread performing pre-operation work. For example, data mover accelerator can issue an interrupt in user space to a network processing thread to indicate copy completion. The user interrupts can interrupt the application (service mesh) and service mesh does not stall waiting for copy completion. In some examples, the interrupt event can be handled by a thread executor and a task currently in progress is not interrupted by a data mover accelerator completion event. One or more network processing threads of a service mesh can register a user interrupt handler function and maintain a hash table mapping interrupt vectors to events. Based on the thread being interrupted by the user interrupts, at 914, user interrupts handler function can be called to activate the corresponding event according to a hash table. The working thread can resume activities after the user interrupts handler finishes.

An operation can be ongoing, completed successfully, or failed due to certain reasons (e.g., invalid memory address). When the thread executor identifies the operation completed successfully (e.g., the destination memory address is filled with content copied from source memory address), at 950, the working thread can continue to perform the post-operation work at 952. If the operation is not completed, operation 906 can follow operation 950.

A thread executor such as Envoy Libevent can identify an active event from an event loop and perform work associated with the active event. When thread executor reaches a submission of a data mover accelerator operation, the following can be added into an event loop. The pointer of the event and data mover accelerator operation work can be dispatched into an independent thread using inter-thread synchronization such as Multi-Producer, Single Consumer (MPSC). The CPU resources of the network processing working thread can be released for other computation work as there is no blocking or polling in the working thread.

For scenario (a) of FIG. 8, an independent thread can submit data mover accelerators operations, and poll for completion. An independent, non-network processing thread can continue to handle monitoring for completion of the data mover accelerator operation. If a data mover accelerator operation is completed, the independent thread can notify an event in another thread with Multi-Producer, Single Consumer (MPSC) or other inter thread synchronization method.

For scenario (b) of FIG. 8, the thread submitting an event to data mover accelerator (e.g., copy) can be awaken in response to a user interrupt indicating completion of the event.

If the data mover accelerator is performing another operation, the independent thread can queue the incoming data mover accelerator operation and merge it with another data mover accelerator operations in a batch operation. After submitting the operation to the data mover accelerator, the dispatcher or non-network processing thread can poll until completion of the submitted operation and activate a corresponding event using a pointer to the event. In the next loop, when the thread executor picks up the event activated, the working thread can continue to do the post-DSA operation work.

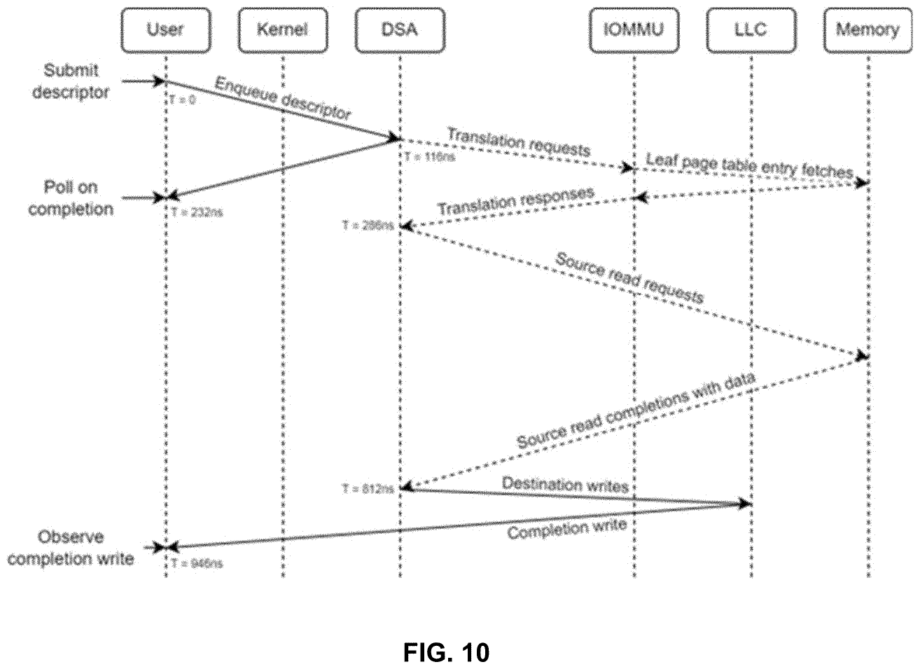

FIG. 10 depicts latency breakdown of a single 4 KB size memory copy by a data mover accelerator. From the perspective of the user, it can take 232 ns to submit the descriptor and 714 ns to poll for completion. During the polling process, the CPU is fully occupied, so it is a trade-off between latency and CPU usage.

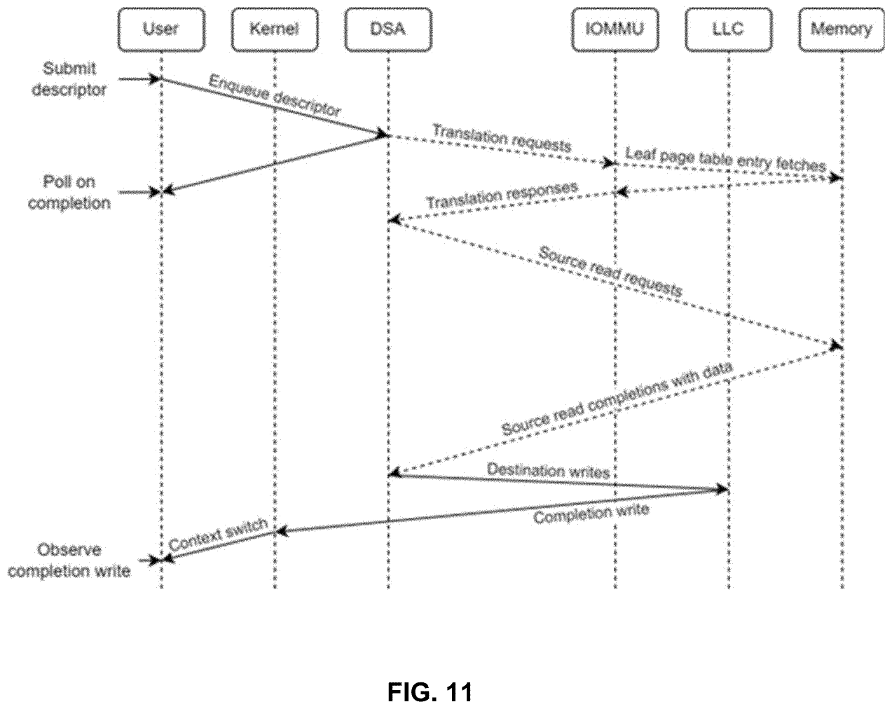

FIG. 11 shows an estimated latency breakdown for hardware interrupt, which can be handled by the kernel. With hardware interrupt, users can execute other jobs while the I/O is waiting completion from the data mover accelerator. For a single memory copy operation performed by a data mover accelerator, the latency of waiting for a hardware interrupt can be larger than the latency of polling because of context switch between kernel space and user space handling hardware interrupt consumes CPU resources, but the saved CPU utilization can be used to process other work.

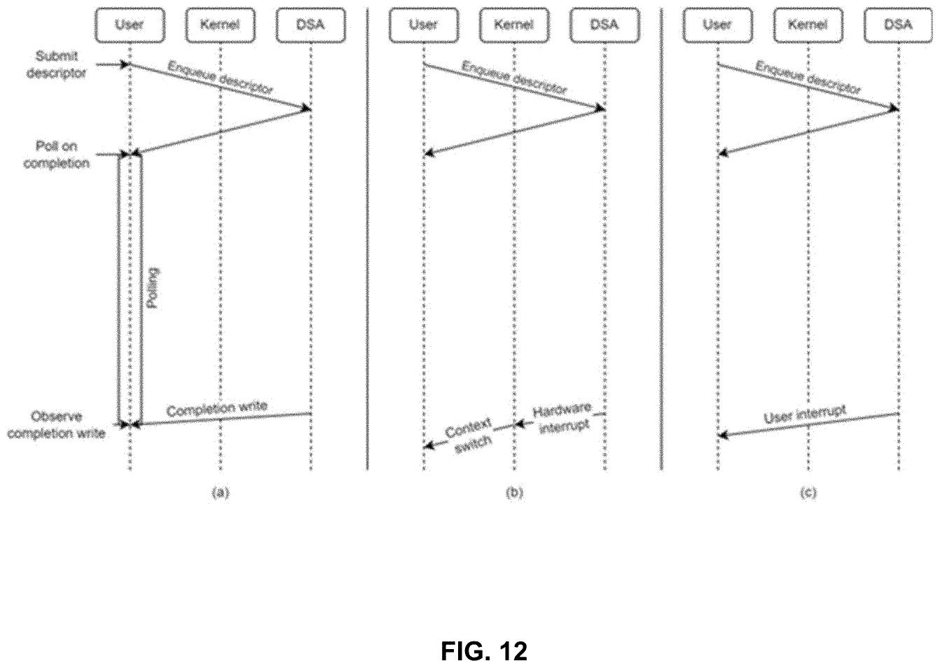

FIG. 12 shows the latency breakdown comparison between data mover accelerator in polling mode, with hardware interrupt and user interrupts. The polling mode approach can have lowest single operation latency but can utilize CPU the most. With hardware interrupts, data mover accelerator can have compatibility with OS and service mesh applications with a potential lower average latency. With user interrupt, data mover accelerator can have the ability to send interrupt directly to the user space and utilizes CPU to bypass kernel space.

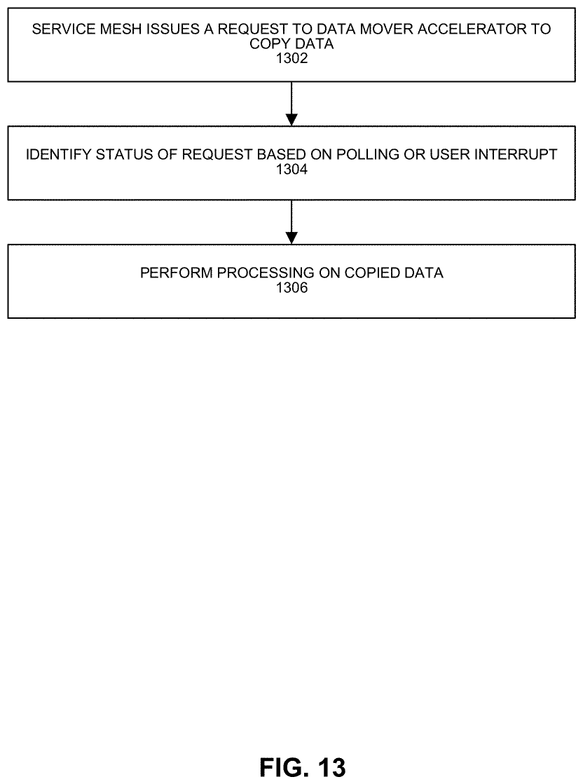

FIG. 13 depicts an example process. At 1302, a service mesh can issue a request to copy data to a data mover accelerator based on a source memory address and a destination memory address. In some examples, the service mesh can batch one or more requests to copy data and provide a batch of requests to the data mover accelerator. At 1304, the service mesh can identify status of the request. For example, the request can be identified as completed by polling for indication of completion or by receipt of a user interrupt that triggers and event handler. At 1306, the service mesh can perform processing operations on the copied data. For example, operations can include data encryption, data decryption, or packet mirroring.

FIG. 14 depicts an example computing system. Components of system 1400 (e.g., processor 1410, accelerators 1442, and so forth) to perform offload of data copy operations to a data mover accelerator (e.g., one or more of accelerators 1442) and detection of status of data copy operations, as described herein. System 1400 includes processor 1410, which provides processing, operation management, and execution of instructions for system 1400. Processor 1410 can include any type of microprocessor, central processing unit (CPU), graphics processing unit (GPU), processing core, or other processing hardware to provide processing for system 1400, or a combination of processors. Processor 1410 controls the overall operation of system 1400, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1400 includes interface 1412 coupled to processor 1410, which can represent a higher speed interface or a high throughput interface for system components that needs higher bandwidth connections, such as memory subsystem 1420 or graphics interface components 1440, or accelerators 1442. Interface 1412 represents an interface circuit, which can be a standalone component or integrated onto a processor die. Where present, graphics interface 1440 interfaces to graphics components for providing a visual display to a user of system 1400. In one example, graphics interface 1440 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1440 generates a display based on data stored in memory 1430 or based on operations executed by processor 1410 or both. In one example, graphics interface 1440 generates a display based on data stored in memory 1430 or based on operations executed by processor 1410 or both.

Accelerators 1442 can be a fixed function or programmable offload engine that can be accessed or used by a processor 1410. For example, an accelerator among accelerators 1442 can provide compression (DC) capability, cryptography services such as public key encryption (PKE), cipher, hash/authentication capabilities, decryption, or other capabilities or services. In some embodiments, in addition or alternatively, an accelerator among accelerators 1442 provides field select controller capabilities as described herein. In some cases, accelerators 1442 can be integrated into a CPU socket (e.g., a connector to a motherboard or circuit board that includes a CPU and provides an electrical interface with the CPU). For example, accelerators 1442 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 1442 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1420 represents the main memory of system 1400 and provides storage for code to be executed by processor 1410, or data values to be used in executing a routine. Memory subsystem 1420 can include one or more memory devices 1430 such as read-only memory (ROM), flash memory, one or more varieties of random access memory (RAM) such as DRAM, or other memory devices, or a combination of such devices. Memory 1430 stores and hosts, among other things, operating system (OS) 1432 to provide a software platform for execution of instructions in system 1400. Additionally, applications 1434 can execute on the software platform of OS 1432 from memory 1430. Applications 1434 represent programs that have their own operational logic to perform execution of one or more functions. Processes 1436 represent agents or routines that provide auxiliary functions to OS 1432 or one or more applications 1434 or a combination. OS 1432, applications 1434, and processes 1436 provide software logic to provide functions for system 1400. In one example, memory subsystem 1420 includes memory controller 1422, which is a memory controller to generate and issue commands to memory 1430. It will be understood that memory controller 1422 could be a physical part of processor 1410 or a physical part of interface 1412. For example, memory controller 1422 can be an integrated memory controller, integrated onto a circuit with processor 1410.

In some examples, OS 1432 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 1400 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1400 includes interface 1414, which can be coupled to interface 1412. In one example, interface 1414 represents an interface circuit, which can include standalone components and integrated circuitry. In one example, multiple user interface components or peripheral components, or both, couple to interface 1414. Network interface 1450 provides system 1400 the ability to communicate with remote devices (e.g., servers or other computing devices) over one or more networks. Network interface 1450 can include an Ethernet adapter, wireless interconnection components, cellular network interconnection components, USB (universal serial bus), or other wired or wireless standards-based or proprietary interfaces. Network interface 1450 can transmit data to a device that is in the same data center or rack or a remote device, which can include sending data stored in memory.

Some examples of network interface 1450 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 1450 include a programmable packet processing pipeline programmed using one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), x86 compatible executable binaries or other executable binaries, or others.

In one example, system 1400 includes one or more input/output (I/O) interface(s) 1460. I/O interface 1460 can include one or more interface components through which a user interacts with system 1400 (e.g., audio, alphanumeric, tactile/touch, or other interfacing). Peripheral interface 1470 can include any hardware interface not specifically mentioned above. Peripherals refer generally to devices that connect dependently to system 1400. A dependent connection is one where system 1400 provides the software platform or hardware platform or both on which operation executes, and with which a user interacts.

In one example, system 1400 includes storage subsystem 1480 to store data in a nonvolatile manner. In one example, in certain system implementations, at least certain components of storage 1480 can overlap with components of memory subsystem 1420. Storage subsystem 1480 includes storage device(s) 1484, which can be or include any conventional medium for storing large amounts of data in a nonvolatile manner, such as one or more magnetic, solid state, or optical based disks, or a combination. Storage 1484 holds code or instructions and data 1486 in a persistent state (e.g., the value is retained despite interruption of power to system 1400). Storage 1484 can be generically considered to be a “memory,” although memory 1430 is typically the executing or operating memory to provide instructions to processor 1410. Whereas storage 1484 is nonvolatile, memory 1430 can include volatile memory (e.g., the value or state of the data is indeterminate if power is interrupted to system 1400). In one example, storage subsystem 1480 includes controller 1482 to interface with storage 1484. In one example controller 1482 is a physical part of interface 1414 or processor 1410 or can include circuits or logic in both processor 1410 and interface 1414.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache.

A non-volatile memory (NVM) device is a memory whose state is determinate even if power is interrupted to the device. In one embodiment, the NVM device can comprise a block addressable memory device, such as NAND technologies. A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of one or more of the above, or other memory.

A power source (not depicted) provides power to the components of system 1400. More specifically, power source typically interfaces to one or multiple power supplies in system 1400 to provide power to the components of system 1400. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1400 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chip-to-chip communications, die-to-die communications, packet-based communications, communications over a device interface, fabric-based communications, and so forth. A die-to-die communications can be consistent with Embedded Multi-Die Interconnect Bridge (EMIB).

FIG. 15 depicts an example system. In this system, IPU 1500 manages performance of one or more processes using one or more of processors 1506, processors 1510, accelerators 1520, memory pool 1530, or servers 1540-0 to 1540-N, where N is an integer of 1 or more. In some examples, processors 1506 of IPU 1500 can execute one or more processes, applications, VMs, containers, microservices, and so forth that request performance of workloads by one or more of: processors 1510, accelerators 1520, memory pool 1530, and/or servers 1540-0 to 1540-N. IPU 1500 can utilize network interface 1502 or one or more device interfaces to communicate with processors 1510, accelerators 1520, memory pool 1530, and/or servers 1540-0 to 1540-N. IPU 1500 can utilize programmable pipeline 1504 to process packets that are to be transmitted from network interface 1502 or packets received from network interface 1502. Programmable pipeline 1504 and/or processors 1506 can be configured (e.g., using P4, and other programming languages) to perform offload of data copy operations to a data mover accelerator (e.g., one or more of accelerators 1520) and detection of status of data copy operations, as described herein.

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade can include components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), micro data center, on-premise data centers, off-premise data centers, edge network elements, fog network elements, and/or hybrid data centers (e.g., data center that use virtualization, serverless computing systems (e.g., Amazon Web Services (AWS) Lambda), content delivery networks (CDN), cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or combination thereof, including “X, Y, and/or Z.’”

Illustrative examples of the devices, systems, and methods disclosed herein are provided below. An embodiment of the devices, systems, and methods may include one or more, and combination of, the examples described below.

Example 1 includes at least one non-transitory computer-readable medium comprising instructions stored thereon, that if executed by one or more processors, cause the one or more processors to: execute a service mesh that is to request a data mover accelerator to perform data copy operations, wherein: allocation of at least one queue accessed by the data mover accelerator to the service mesh is based on occupancy of the at least one queue, the service mesh is to provide work requests to the allocated at least one queue by batching of work requests, and based on support of receipt of user interrupts from the data mover accelerator, the service mesh is to receive an indicator of work request status by a user interrupt.

Example 2 includes one or more examples, wherein the allocation of at least one queue accessed by the data mover accelerator to the service mesh is based on occupancy of the at least one queue comprises allocate at least one queue to the service mesh based also on busyness of a processor that executes the service mesh.

Example 3 includes one or more examples, and includes instructions stored thereon, that if executed by one or more processors, cause the one or more processors to: allocate zero queue to the service mesh based on the busyness of a processor that executes the service mesh and allow the processor to perform the data copy operations.

Example 4 includes one or more examples, wherein: based on lack of support for receipt of user interrupts from the data mover accelerator, the service mesh is to poll for an indicator of work request status to determine whether to proceed to the operation after the data copy.

Example 5 includes one or more examples, wherein the poll for an indicator of work request status comprises read a status indicator associated with a batch of multiple work requests.

Example 6 includes one or more examples, wherein the operation after the data copy comprises a data encryption operation.

Example 7 includes one or more examples, wherein the operation after the data copy comprises a packet mirroring operation.

Example 8 includes one or more examples, wherein to receive an indicator of work request status by a user interrupt comprises receive a write to a register that triggers an interrupt handler to cause a read of the work request status.

Example 9 includes one or more examples, wherein the service mesh comprises Envoy.

Example 10 includes one or more examples, wherein the data mover accelerator is to perform a copy operation in response to an instruction from the service mesh and provide a status of the copy operation.

Example 11 includes one or more examples, and includes a system comprising: a data mover accelerator and circuitry configured to: execute a service mesh that is to request a data mover accelerator to perform data copy operations and receive indication of status of the data copy operations by user interrupt.

Example 12 includes one or more examples, wherein allocation of at least one queue accessed by the data mover accelerator to the service mesh is based on occupancy of the at least one queue and busyness of a processor that executes the service mesh.

Example 13 includes one or more examples, wherein the service mesh is to provide work requests to the allocated at least one queue by batching of work requests.

Example 14 includes one or more examples, wherein based on lack of support for receipt of user interrupts from the data mover accelerator, the service mesh is to poll for an indicator of work request status to determine whether to proceed to the operation after the data copy.

Example 15 includes one or more examples, wherein the operation after the data copy comprises a data encryption operation and/or a packet mirroring operation.

Example 16 includes one or more examples, and includes a method comprising: executing a service mesh that is to request a data mover accelerator to perform data copy operations and receive indication of status of the data copy operations by user interrupt.

Example 17 includes one or more examples, and includes allocating at least one queue accessed by the data mover accelerator to the service mesh based on occupancy of the at least one queue and busyness of a processor that executes the service mesh.

Example 18 includes one or more examples, and includes the service mesh providing work requests to the allocated at least one queue by batching of work requests.

Example 19 includes one or more examples, and includes based on lack of support for receipt of user interrupts from the data mover accelerator, the service mesh is to poll for an indicator of work request status to determine whether to proceed to the operation after the data copy.

Example 20 includes one or more examples, wherein the operation after the data copy comprises a data encryption operation and/or a packet mirroring operation.

Example 21 includes one or more examples, and includes at least one non-transitory computer-readable medium comprising instructions stored thereon, that if executed by one or more processors, cause the one or more processors to: select a strict subset of threads to not use a data mover accelerator based on processor utilization.

Example 22 includes one or more examples, and includes instructions stored thereon, that if executed by one or more processors, cause the one or more processors to: allocate at least one queue accessed by the data mover accelerator to the strict subset of threads based on occupancy of the at least one queue and busyness of a processor that executes the strict subset of threads.

Example 23 includes one or more examples, wherein the strict subset of threads is to provide work requests to the allocated at least one queue by batching of work requests.

1. At least one non-transitory computer-readable medium comprising instructions stored thereon, that if executed by one or more processors, cause the one or more processors to:
execute a service mesh that is to request a data mover accelerator to perform data copy operations, wherein:
allocation of at least one queue accessed by the data mover accelerator to the service mesh is based on occupancy of the at least one queue,
the service mesh is to provide work requests to the allocated at least one queue by batching of work requests, and
based on support of receipt of user interrupts from the data mover accelerator, the service mesh is to receive an indicator of work request status by a user interrupt.

2. The computer-readable medium of claim 1, wherein the allocation of at least one queue accessed by the data mover accelerator to the service mesh is based on occupancy of the at least one queue comprises allocate at least one queue to the service mesh based also on busyness of a processor that executes the service mesh.

3. The computer-readable medium of claim 2, comprising instructions stored thereon, that if executed by one or more processors, cause the one or more processors to:
allocate zero queue to the service mesh based on the busyness of a processor that executes the service mesh and allow the processor to perform the data copy operations.

4. The computer-readable medium of claim 1, wherein:
based on lack of support for receipt of user interrupts from the data mover accelerator, the service mesh is to poll for an indicator of work request status to determine whether to proceed to the operation after the data copy.

5. The computer-readable medium of claim 4, wherein the poll for an indicator of work request status comprises read a status indicator associated with a batch of multiple work requests.

6. The computer-readable medium of claim 1, wherein the operation after the data copy comprises a data encryption operation.

7. The computer-readable medium of claim 1, wherein the operation after the data copy comprises a packet mirroring operation.

8. The computer-readable medium of claim 1, wherein to receive an indicator of work request status by a user interrupt comprises receive a write to a register that triggers an interrupt handler to cause a read of the work request status.

9. The computer-readable medium of claim 1, wherein the service mesh comprises Envoy.

10. The computer-readable medium of claim 1, wherein the data mover accelerator is to perform a copy operation in response to an instruction from the service mesh and provide a status of the copy operation.

11. A system comprising:
a data mover accelerator and
circuitry configured to:
execute a service mesh that is to request a data mover accelerator to perform data copy operations and receive indication of status of the data copy operations by user interrupt.

12. The system of claim 11, wherein allocation of at least one queue accessed by the data mover accelerator to the service mesh is based on occupancy of the at least one queue and busyness of a processor that executes the service mesh.

13. The system of claim 12, wherein the service mesh is to provide work requests to the allocated at least one queue by batching of work requests.

14. The system of claim 11, wherein based on lack of support for receipt of user interrupts from the data mover accelerator, the service mesh is to poll for an indicator of work request status to determine whether to proceed to the operation after the data copy.

15. The system of claim 11, wherein the operation after the data copy comprises a data encryption operation and/or a packet mirroring operation.

16. A method comprising:
executing a service mesh that is to request a data mover accelerator to perform data copy operations and receive indication of status of the data copy operations by user interrupt.

17. The method of claim 16, comprising:
allocating at least one queue accessed by the data mover accelerator to the service mesh based on occupancy of the at least one queue and busyness of a processor that executes the service mesh.

18. The method of claim 17, comprising:
the service mesh providing work requests to the allocated at least one queue by batching of work requests.

19. The method of claim 17, comprising:
based on lack of support for receipt of user interrupts from the data mover accelerator, the service mesh is to poll for an indicator of work request status to determine whether to proceed to the operation after the data copy.

20. The method of claim 17, wherein the operation after the data copy comprises a data encryption operation and/or a packet mirroring operation.

21. At least one non-transitory computer-readable medium comprising instructions stored thereon, that if executed by one or more processors, cause the one or more processors to:
select a strict subset of threads to not use a data mover accelerator based on processor utilization.

22. The computer-readable medium of claim 21, comprising instructions stored thereon, that if executed by one or more processors, cause the one or more processors to:
allocate at least one queue accessed by the data mover accelerator to the strict subset of threads based on occupancy of the at least one queue and busyness of a processor that executes the strict subset of threads.

23. The computer-readable medium of claim 22, wherein the strict subset of threads is to provide work requests to the allocated at least one queue by batching of work requests.
